(19) United States
(12) Patent Application Publication
(10) Pub. No.: US 2008/0247812 A1
(43) Pub. Date: Oct. 9, 2008

(54) Furniture item having at least a first and a second furniture portion

(76) Inventor: Thomas Embacher, Lauterach (AT)

Correspondence Address: WENDEROTH, LIND & PONACK, L.L.P., 2033 K STREET N. W., SUITE 800, WASHINGTON, DC, 20006-1021, US

(21) Appl. No.: 12/213,071

(22) Filed: Jun. 13, 2008

Related U.S. Application Data
(63) Continuation of application No. PCT/AT2006/000511, filed on Dec. 12, 2006.

(30) Foreign Application Priority Data
Dec. 15, 2005 (AU) A 2006/2005

(51) Int. Cl. F16B 9/00

(52) U.S. Cl. 403/231

(57) ABSTRACT

Piece of furniture (1) having at least a first furniture part (3) and a second furniture part (4), of which one furniture part (3) is mounted in a stationary, manner, and the other furniture part (4) is mounted in a movable manner, on the basic furniture structure (2) and which can be moved relative to one another, and having a lockable pushing-out device (5) which is arranged on the first furniture part (3) and is intended for moving the movable furniture part (4) from a closed end position into an open position, and having an engagement element (8) which is arranged on the second furniture part (4) and engages with the pushing-out device (5) at least over a part of the opening/closing path (OR, SR) of the movable furniture part, the engagement element (8) being mounted on the second furniture part (4) such that it can be adjusted preferably in linear fashion in relation to the first furniture part (3).

The invention concerns a furniture item having at least a first and a second furniture portion of which one furniture portion is mounted stationarily and the other furniture portion is mounted movably to the furniture carcass and which are movable relative to each other, and a lockable ejection device arranged on the first furniture portion for moving the movable furniture portion out of a closed end position into an open position and an engagement element which is arranged on the second furniture portion and which at least in a part of the opening/closing path of the movable furniture portion is in engagement with the ejection device.

Furniture items comprising a movable furniture portion and a lockable ejection device for moving the movable furniture portion out of a closed end position into an open position are known per se. In those arrangements the lockable ejection device permits opening of a handle-less movable furniture portion at least to such an extent that it is possible to grip behind the front panel and open the drawer even without the presence of a handle fitment. In that case, unlocking of the ejection device can be effected for example by way of a button or, in the case of what are referred to as touch-latch fitments, by applying a pressure to the front panel in the closing direction of the movable furniture portion.

In order in that case to be able to adjust the front gap which exists in the closed position of a drawer between the inside of its front panel and the front end faces of the carcass walls of a furniture item, it is further known from DE 20 2004 019 738 U1 for the housing of the opening and closing device which is in the form of a touch-latch mechanism and which is integrated in the extension guide system to be formed to be displaceable in the longitudinal direction and fixable in selectable longitudinal adjusted positions.

The object of the invention is to provide a furniture item of the general kind set forth which on the one hand permits uncomplicated alteration to the front gap and which on the other hand has a structurally simple adjustment mechanism.

According to the invention that object is attained in that the engagement element is mounted on the second furniture portion preferably linearly displaceably with respect to the first furniture portion.

The fact that in accordance with the invention now only the position of the engagement element which can be for example in the form of a hook or pin has to be altered in order to adapt the front gap affords a more stable structure which is easier to adjust in comparison with the state of the art as the opening and closing mechanism which in itself already requires precise adjustment, particularly when it is in the form of a touch-latch mechanism, can remain unchanged.

It is preferably provided in that respect that the first furniture portion is mounted stationarily to the furniture item carcass so that the position of the engagement element which in this case is arranged on the movable furniture portion can be easily altered in an open position of the movable furniture portion without the movable furniture portion having to be removed from the carcass of the article of furniture.

It will be appreciated that it is also possible that the second furniture portion with the engagement element is mounted stationarily to the furniture item carcass, wherein in that case it should be noted that the engagement element is positioned in such a way that access to the engagement element is possible in an open position of the first furniture portion which in this case is movable.

The position of the engagement element can be particularly easily altered when in accordance with a further embodiment of the invention the engagement element is mounted on the second furniture portion adjustably displaceably by means of a displacement device, wherein it has proven to be desirable if the displacement device has a housing which is arranged on the second furniture portion and in which the engagement element is mounted movably in the opening/closing direction of the movable furniture portion. By virtue of the arrangement of the engagement element in a housing the housing serves as it were as a guide for the engagement element, whereby a change in position of the engagement element with respect to the first furniture portion can be effected without manipulation on the second furniture portion.

In accordance with a preferred embodiment of the invention it is provided in that respect that the preferably self-locking displacement device is formed to convert a rotary movement into a translatory movement, wherein a rotatably mounted actuating element which has a spiral-shaped sliding guide is operatively connected to the linearly movable engagement element, wherein, for simple access to the engagement element, it has proven desirable if the axis of rotation of the actuating element includes a substantially right angle with the direction of movement of the engagement element. That on the one hand permits comfortable operation of the displacement device and on the other hand ensures stepless longitudinal displacement of the engagement element which, if it is of a self-locking nature, remains in any position once set, without further assistance. Although it would be basically conceivable for the lockable ejection device to be released by means of a separate touch device or pushbutton, a preferred, particularly user-friendly embodiment of the invention provides that the lockable ejection device is in the form of a touch-latch mechanism.

In that respect, in accordance with a structurally particularly simple solution it is provided that the lockable ejection device is arranged in a housing and has a receiving element which is mounted movably in the housing and which is adapted for engagement with the engagement element arranged on the second furniture portion, wherein it has proven to be desirable if the direction of movement of the movable receiving element in the housing includes an angle of greater than zero, preferably between 2° and 15°, with the opening/closing direction of the movable furniture portion.

In other words, the receiving element of the lockable ejection device is guided in a straight, inclinedly extending guide path, at one end of which it is in engagement with the engagement element while at the other opposite end it is out of engagement with the engagement element. In that way curved or heart-shaped guide slides as are known from the state of the art and which entail an elevated rate of material wear can be avoided.

Further details and advantages of the present invention will be described more fully on the basis of the specific description with reference to the embodiments by way of example illustrated in the drawing in which:

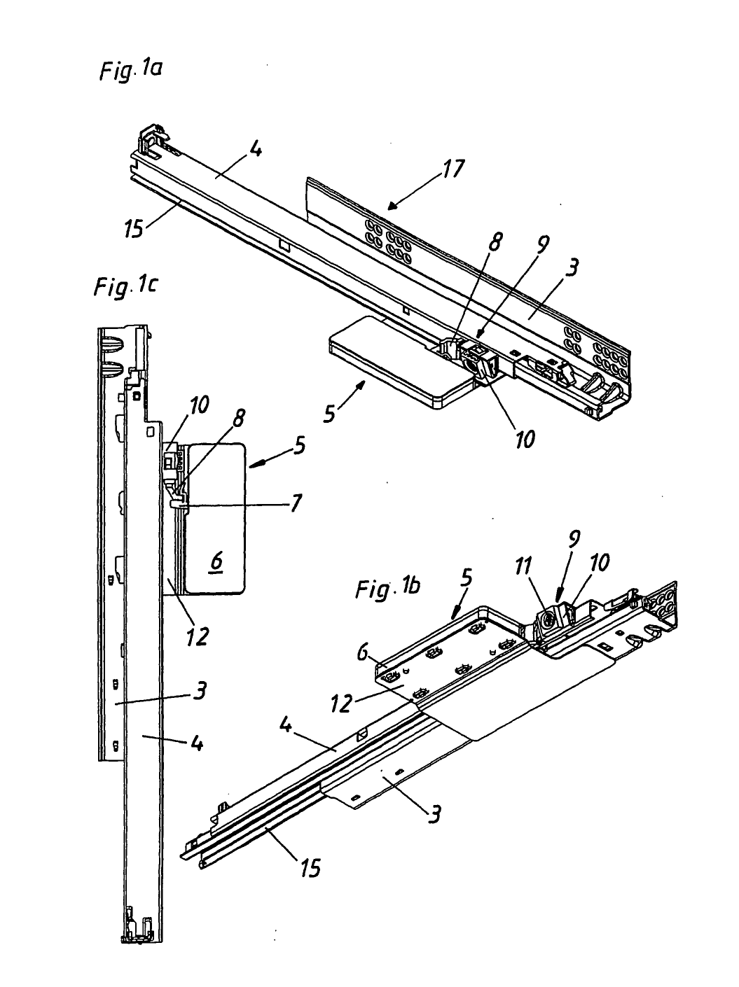

FIGS. 1a through 1c show an oblique view from above, an oblique view from below and a plan view of a first and a second furniture portion which are movable relative to each other,

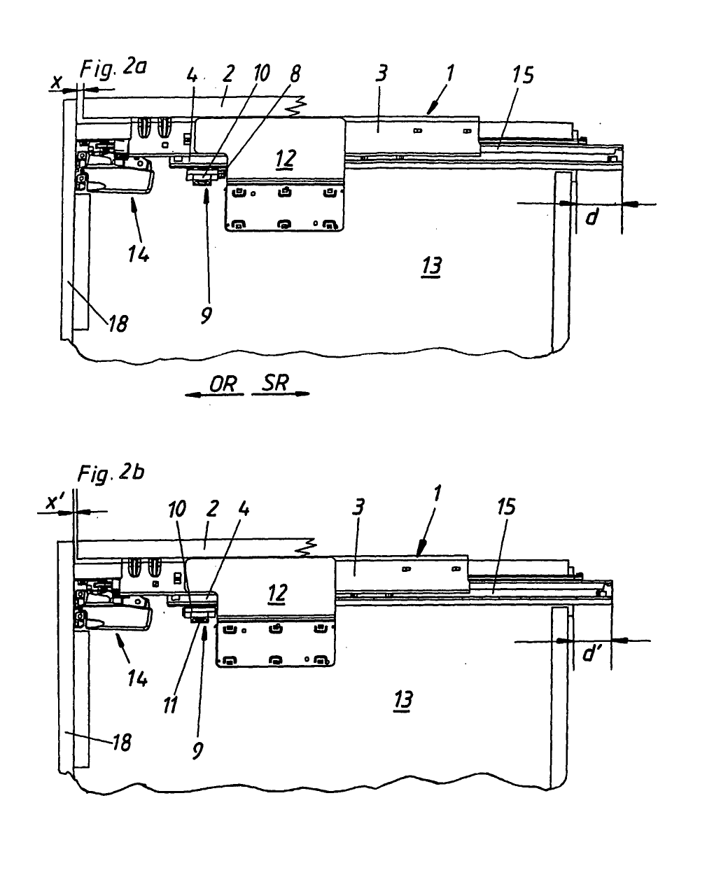

FIGS. 2a and 2b show a view from below of a part of a furniture item with a drawer in two different positions,

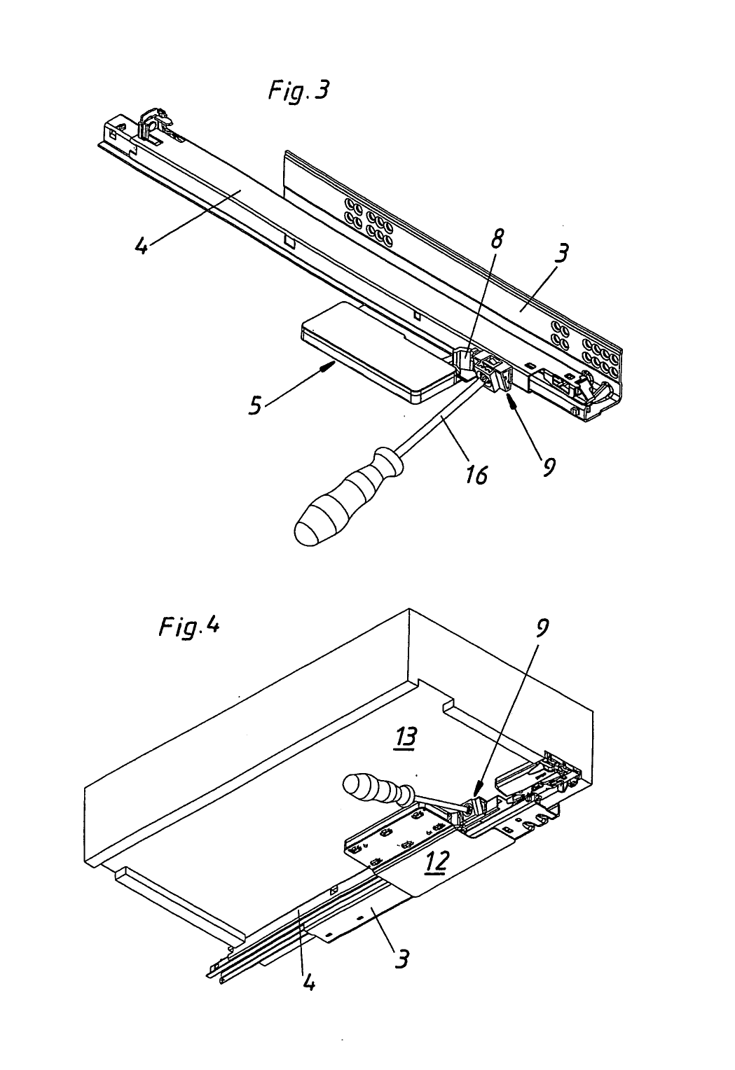

FIG. 3 shows the embodiment of FIG. 1 with a tool for displacement of the engagement element,

FIG. 4 shows an oblique view from below of the embodiment of FIG. 3 with the drawer fixed, and

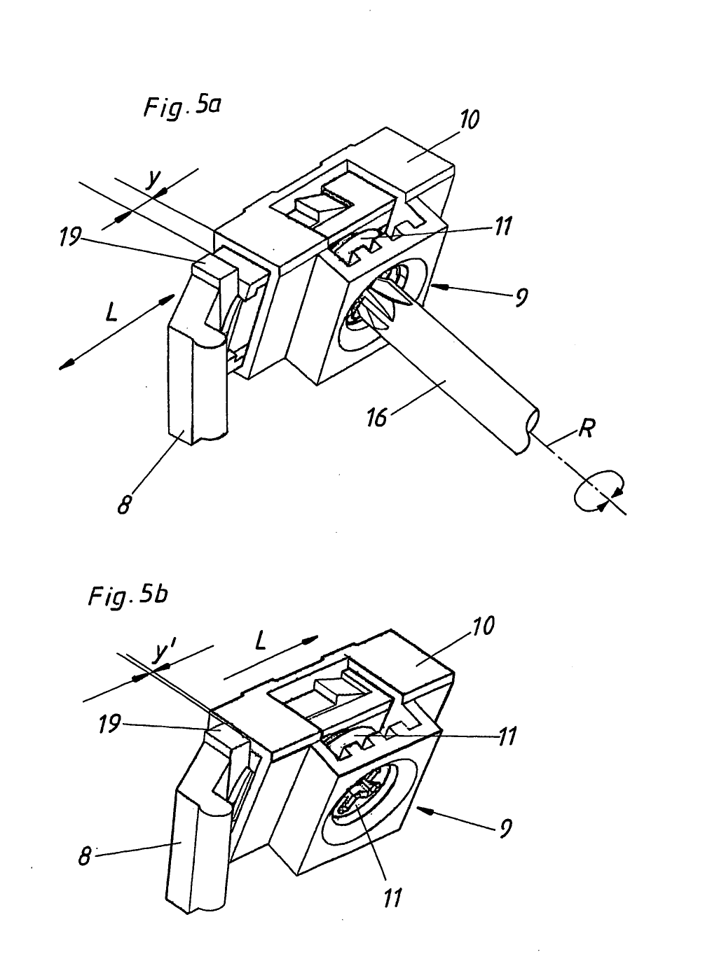

FIGS. 5a and 5b show the displacement device for the engagement element in two different positions of the engagement element.

FIGS. 1a through 1c show an extension guide 17 for a drawer, which includes a first furniture portion 3 in the form of a carcass rail, a second furniture portion 4 in the form of a drawer rail and a intermediate rail 15 disposed between the first furniture portion 3 and the second furniture portion 4. The extension guide 17 is mounted to the carcass of furniture item (not shown) stationarily by way of the first furniture portion 3. The housing 6 of a lockable ejection device 5 is fixed to the first furniture portion 3 by way of a mounting plate 12 (FIG. 1b). Arranged on the second furniture portion 4 which is movable relatively to the first furniture portion 3 is an engagement element 8 which is adapted to engage with the receiving element 7 (FIG. 1c) of the lockable ejection device 5, in such a way that the engagement element 8 is linearly adjustably displaceable in the housing 10 of a displacement device 9, more specifically by way of the actuating element 11.

The linear displaceability of the engagement element 8 serves to, be able to adjust the front gap between the front panel 18 of the drawer 13 and the furniture carcass, as is shown in FIGS. 2a and 2b.

It will be seen from FIG. 2a that the drawer 13 with its front panel 18 is fixed to the second movable furniture portion 4 by way of a fixing device 14. In the illustrated embodiment the second movable furniture portion 4 forms the drawer rail on which the engagement element 8 is mounted linearly movably in the housing 10 of the displacement device 9. The second movable furniture portion 4 is connected to the first furniture portion 3 movably relative thereto, with the interposition of the intermediate rail 15. In the illustrated embodiment the first furniture portion 3 is formed by the carcass rail arranged stationarily on the carcass 2 of the furniture item 1. The lockable ejection device 5 is fixed to the first furniture portion 3 by means of a fixing plate 12.

In order to alter the front gap, as shown in FIGS. 3 and 4, the actuating element 11 of the displacement device 9 is actuated by means of a suitable tool 16, in this case a screwdriver, whereby the position of the engagement element 8 is altered in the opening/closing direction OR. Starting from the position shown in FIG. 2a the actuating element 11 of the displacement device is rotated towards the left whereby the engagement element 8 is also moved towards the left, that is to say further into the housing 10 of the displacement device 9 (FIG. 2b). That linear displacement of the engagement element 8 also altered the relative position of the second movable furniture portion 4 with respect to the first stationary furniture portion 3—upon engagement of the engagement element 8 with the receiving element 7 of the lockable ejection device—so that the front gap x′ shown in FIG. 2b is smaller by the magnitude of the linear movement of the engagement element 8, than the front gap x shown in FIG. 2a. The spacing d of the rear end of the drawer 13 from the rear end of the intermediate rail 15 is shortened by the same amount to the spacing d′ shown in FIG. 2b.

FIGS. 5a and 5b show in detail the displacement device 9 in two different positions of the engagement element 8. In this case the engagement element 8 is mounted in the housing 10 linearly movably in the direction of movement L and is operatively connected to the actuating element 11 rotatable about its axis of rotation R. On its side towards the engagement element 8 the actuating element 11 has a spiral-shaped sliding guide which engages into a tooth arrangement on the engagement element 8. That arrangement provides that a rotary movement of the actuating element 11 about its axis of rotation R is converted into a translatory movement of the engagement element 8 in the direction of movement L, the axis of rotation R including a substantially right angle with the direction of movement L in the illustrated embodiment. On its side opposite the spiral-shaped sliding guide the actuating element 11 is adapted for engagement with a tool 16.

If now, starting from the position shown in FIG. 5a, the actuating element 11 is rotated about its axis of rotation R by means of the tool 16 the engagement element 8 moves towards the right further into the housing 10 of the displacement device 9, whereby the spacing y between the abutment 19 of the engagement element 8 and the housing 10 (FIG. 5a) decreases to the spacing y′ shown in FIG. 5b. In that respect the amount by which the spacing between the abutment 19 and the housing 10 changes corresponds to the amount by which the front gap between the front panel 18 and the carcass 2 of the article of furniture changes.

Arranging the actuating element 11 of the displacement device 9 in a plane extending inclinedly relative to the plane of the engagement element 8 has the advantage that the tooth arrangement on the engagement element 8 cannot leave the spiral-shaped sliding guide on the actuating element 11, thereby affording a longer displacement travel for the engagement element 8 in the direction of movement L.

The illustrated embodiments of depthwise displacement of a movable furniture portion in relation to the carcass of the furniture item for adjustment of the front gap are obviously not to be interpreted in a restrictive sense but only as individual examples of numerous possible ways of carrying the concept of the invention of a furniture item with an adjustment mechanism for the front gap into effect.

1. A furniture item having at least a first and a second furniture portion of which one furniture portion is mounted stationarily and the other furniture portion is mounted movably to the furniture carcass and which are movable relative to each other, and a lockable ejection device arranged on the first furniture portion for moving the movable furniture portion out of a closed end position into an open position and an engagement element which is arranged on the second furniture portion and which at least in a part of the opening/closing path of the movable furniture portion is in engagement with the ejection device, wherein the engagement element is mounted on the second furniture portion displaceably with respect to the first furniture portion.

2. A furniture item according to claim 1, wherein the second furniture portion is mounted linearly displacably with respect to the first furniture portion.

3. A furniture item according to claim 1, wherein the first furniture portion is mounted stationarily to the furniture carcass.

4. A furniture item as according to claim 1, wherein the second furniture portion is mounted stationarily to the furniture carcass.

5. A furniture item according to claim 1, wherein the engagement element is mounted on the second furniture portion adjustably displaceably by means of a displacement device.

6. A furniture item according to claim 5, wherein the displacement device has a housing which is arranged on the second furniture portion and in which the engagement element is mounted displaceably in the opening/closing direction of the movable furniture portion.

7. A furniture item according to claim 5, wherein the displacement device is adapted to convert a rotary movement into a translatory movement, wherein a rotatably mounted actuating element which has a spiral-shaped sliding guide is operatively connected to the linearly movable engagement element.

8. A furniture item according to claim 5, wherein the displacement device is formed to be self-locking.

9. A furniture item according to claim 7, wherein the axis of rotation of the actuating element includes a substantially right angle with the direction of movement of the engagement element.

10. A furniture item according to claim 1, wherein the lockable ejection device is in the form of a touch-latch mechanism.

11. A furniture item according to claim 1, wherein the lockable ejection device is arranged in a housing and has a receiving element which is mounted movably in the housing and which is adapted for engagement with the engagement element arranged on the second furniture portion.

12. A furniture item according to claim 11, wherein the direction of movement of the movable receiving element in the housing includes an angle of greater than zero with the opening/closing direction of the movable furniture portion.

13. A furniture item according to claim 11, wherein the direction of movement of the movable receiving element in the housing includes an angle of between 2° and 15° with the opening/closing direction of the movable furniture portion.
